(19) United States
(12) Patent Application Publication
(10) Pub. No.: US 2026/0311901 A1
(43) Pub. Date: Oct. 8, 2026

(54) NUCLEAR REACTOR LOADING SYSTEM AND METHODS OF USE THEREOF

(71) Applicant: Abilene Christian University, Abilene, TX (US)

(72) Inventors: Jonathan Scherr, Abilene, TX (US); Jack Shoemate, Abilene, TX (US)

(21) Appl. No.: 19/259,548

(22) Filed: Jul. 3, 2025

Related U.S. Application Data
(63) Continuation of application No. 19/038,206, filed on Jan. 27, 2025.
Application No. 19/038,206 is a continuation of application No. 18/930,802, filed on Oct. 29, 2024.
(60) Provisional application No. 63/595,541, filed on Nov. 2, 2023.

(51) Int. Cl. G21C 19/04; G21C 1/22; G21C 3/24; G21C 3/28; G21C 3/54

(52) U.S. Cl. CPC G21C 19/04; G21C 1/22; G21C 3/24; G21C 3/28; G21C 3/54

(57) ABSTRACT

A loading system for a molten salt reactor system includes a slug loading assembly. The slug loading assembly includes an inert chamber having an entry port therein that is configured to receive a solid slug. The loading system further includes a chute having a pipe run extending from the entry port and elevationally below the slug loading assembly. The loading system further includes a terminal sieve fluidically coupled with the pipe run opposite the entry port and configured to receive the solid slug via the pipe run. The terminal sieve is positionable with a flow of a liquid molten salt for dissolution of the solid slug therein.

### RELATED APPLICATIONS

The present application relates and claims priority to U.S. Provisional Application No. 63/595,541, filed on Nov. 2, 2023, which is hereby incorporated by reference in its entirety.

### TECHNICAL FIELD

The described examples relate generally to systems, devices, and techniques for loading a molten salt nuclear reactor.

### BACKGROUND

A molten salt reactor (“MSR”) is a type of nuclear fission reactor which uses a molten salt in a reactor core, where fission occurs. Broadly, MSRs may include a collection of components configured to circulate a molten fuel salt along a fuel salt loop. For example, an MSR may operate by circulating a molten fuel salt between a reactor vessel (within which fission occurs) and a heat exchanger (for the removal of heat from the fuel salt). In some types of MSRs, fission occurs within the molten salt itself because the salt contains a fissile material. An MSR may be operated in a manner whereby the fissile or fertile content of the molten salt (the fuel) may need to be adjusted during operation. For example, it be desirable to adjust a content or composition of the molten salt while said molten salt continues to flow through the system, along the fuel salt loop. However, heat, radioactivity, and/or other hazards may hinder the practicality of adjusting the molten salt during operation. As such, there is a need for systems and techniques to facilitate the adjusting of the molten salt during operation, such as adjusting a content of the molten salt while the molten salt continues to flow along the molten salt loop of the MSR.

### SUMMARY

In one example, a loading system for a molten salt reactor system is disclosed. The loading system includes a slug loading assembly having an inert chamber with an entry port therein. The entry port is configured to receive a solid slug therein. The loading system further includes a chute having a pipe run extending from the entry port and elevationally below the slug loading assembly. The loading system further includes a terminal sieve fluidically coupled with the pipe run opposite the entry port and configured to receive the solid slug via the pipe run. The terminal sieve is positionable with a liquid molten salt for dissolution of the solid slug therein.

In another example, the terminal sieve may include a tube defining a series of perforated slits that fluidically expose an interior of the tube.

In another example, the tube may be configured to receive the solid slug and hold the solid slug adjacent the series of perforated slits. In this regard, the series of perforated slits are configured to receive a portion of the liquid molten salt and to direct the portion to the solid slug for dissolution of the solid slug into the liquid molten salt.

In another example, the loading system includes a throughput line fluidically coupling an end of the tube to another portion of a molten salt loop. In this regard, the throughput line may be configured to receive a dissolution of molten salt from the tube.

In another example, the solid slug may be a solid fuel slug including fissile material. Additionally, the liquid molten salt may be a refueling segment of a molten salt loop configured to circulate the liquid molten salt through a reactor vessel, a reactor access vessel, a reactor pump, and a heat exchanger. In this regard, the refueling segment may be defined within the reactor access vessel.

In another example, the refueling segment may include the liquid molten salt having a temperature of in excess of 550° C.

In another example, the pipe run may include a doubled walled pipe extending between a containment region associated with the terminal sieve and an outer region associated with the slug loading assembly.

In another example, the chute includes a first isolation valve arranged within the containment region and configured to fully close the pipe run and a second isolation valve arranged within the outer region and configured to fully close the pipe run.

In another example, the slug loading assembly includes a glove box defining the inert chamber about the entry port and a vacuum chamber defining an entrance to the glove box.

In another example, the chute may also include a third valve configured to selectively isolate the entry port from the pipe run and the glove box may include a coupling mechanism configured to removably attach the glove box to the pipe run.

In another example, the slug loading assembly may further include an entry mechanism having an entry pipe portion that defines the entry port and is fluidically coupled with the pipe run of chute and a loading door operable to receive the solid slug and for selectively closing the entry port. The loading door encourages the entry of the solid slug into the entry port upon the loading door closing the entry port.

In another example, the slug loading assembly may further include a release plate arranged at a first position in which the release plate is intersecting the entry pipe portion and blocking a path of the solid fuel slug therein. The release plate may be transitionable from the first position to a second position in which the release plate is at least partially removed from the entry pipe portion and out of the path of the solid fuel slug.

In another example, a molten salt reactor system is disclosed. The molten salt reactor system includes a molten salt loop configured to circulate a liquid molten salt through a reactor vessel, a reactor access vessel, a reactor pump, and/or a heat exchanger. The system further includes a containment structure defining a containment region at least partially encompassing the molten salt loop. The system further includes a loading system configured to introduce a solid slug into the liquid molten salt in the loop from an outer region outside the containment region.

In another example, the loading system may include a chute having a pipe run extending between the outer region and the containment region. In this regard, the containment region being elevationally below the outer region.

In another example, the chute may include a first isolation valve within the containment region and configured to fully close the pipe run and a second isolation valve arranged within the outer region and configured to fully close the pipe run.

In another example, the loading system may further include a slug loading assembly including an inert chamber having an entry port therein. In this regard, the entry port may be configured to receive a solid slug therein and direct the solid slug toward the pipe run. The loading system may further include a terminal sieve fluidically coupled with the pipe run opposite the entry port and configured to receive the solid slug via the pipe run. In this regard, the terminal sieve is positionable with the liquid molten salt for dissolution of the solid slug therein.

In another example, the terminal sieve is positioned in the reactor access vessel.

In another example, the slug loading assembly further includes a glove box defining the inert chamber about the entry port and a vacuum chamber defining an entrance to the glove box. In this regard, the glovebox includes a coupling mechanism configured to removably attach the glove box to the pipe run.

In yet another example, a method for loading a molten salt reactor system is disclosed. The method includes loading a solid slug into a slug loading assembly of a loading system. The method further includes inserting the solid slug into an entry port arranged within an inert chamber of the slug loading assembly. The method further includes causing the solid slug to drop through a chute of the slug loading assembly. In this regard, the chute may extend from the entry port and elevationally below the inert chamber. The method further includes receiving the solid slug at a terminal sieve of the loading system, the terminal sieve positioned at an end of the pipe run opposite the entry port. The method may further include causing the solid slug held within the terminal sieve to dissolve into a liquid molten salt.

In another example, the method further includes circulating the liquid molten salt through a molten salt loop. In this regard, the molten salt loop includes a reactor vessel, a reactor access vessel, a reactor pump, and/or a heat exchanger.

In another example, the causing may further include causing entry of the liquid molten salt into a series of perforated slits of the terminal sieve.

In another example, the method further includes operating the slug loading assembly by arranging the solid slug on a loading door, and selectively closing the loading door to encourage entry of the solid slug into the entry port.

In another example, the method further includes storing one or both of the solid slug or constituent components thereof proximal the slug loading assembly and preparing the solid slug for entrance into the entry port.

In one example, a refueling system for a molten salt reactor system is disclosed. The refueling system includes a fuel slug loading assembly having an inert chamber with an entry port therein. The entry port is configured to receive a solid fuel slug therein. The refueling system further includes a chute having a pipe run extending from the entry port and elevationally below the fuel slug loading assembly. The refueling system further includes a terminal sieve fluidically coupled with the pipe run opposite the entry port and configured to receive the solid fuel slug via the pipe run. The terminal sieve is positionable with a liquid molten fuel salt for dissolution of the solid fuel slug therein.

In another example, the terminal sieve may include a tube defining a series of perforated slits that fluidically expose an interior of the tube.

In another example, the tube may be configured to receive the solid fuel slug and hold the solid fuel slug adjacent to the series of perforated slits. In this regard, the series of perforated slits may be configured to receive a portion the liquid molten salt and to direct the portion to the solid fuel slug for dissolution of the solid fuel slug into the liquid molten fuel salt.

In another example, the refueling system may further include a throughput line fluidically coupling an end of the tube to another portion of a molten salt loop, the throughput line configured to receive a dissolution of molten salt from the tube.

In another example, the liquid molten fuel salt may be a refueling segment of a molten salt loop configured to circulate the liquid molten fuel salt through a reactor vessel, a reactor access vessel, a reactor pump, and a heat exchanger. In turn, the refueling segment may be defined within the reactor access vessel.

In another example, the refueling segment may include the liquid molten fuel salt having a temperature of in excess of 550° C.

In another example, the pipe run includes a doubled walled pipe extending between a containment region associated with the terminal sieve and an outer region associated with the fuel slug loading assembly.

In another example, the chute may include a first isolation valve arranged within the containment region that is configured to fully close the pipe run. The chute may further include a second isolation valve arranged within the outer region and configured to fully close the pipe run.

In another example, the fuel slug loading assembly may include a glove box defining the inert chamber about the entry port. The fuel slug loading assembly may further include a vacuum chamber defining an entrance to the glove box.

In another example, the fuel slug loading assembly may further include an entry mechanism having an entry pipe portion that defines the entry port and that is fluidically coupled with the pipe run of chute. The fuel slug loading assembly may further include a loading door operable to receive the solid fuel slug and for selectively closing the entry port. The loading door may encourage the entry of the solid fuel slug into the entry port upon the loading door closing the entry port.

In another example, the fuel slug loading assembly may further include a release plate arranged at a first position in which the release plate is intersecting the entry pipe portion and blocking a path of the solid fuel slug therein. The release plate may be transitionable form the first position to a second position in which the release plate is at least partially removed from the entry pipe portion and out of the path of the solid fuel slug.

In another example, a molten salt reactor system is disclosed. The molten salt reactor system includes a molten salt loop configured to circulate a liquid molten fuel salt through a reactor vessel, a reactor access vessel, a reactor pump, and a heat exchanger. The molten salt reactor system further includes a containment structure defining a containment region encompassing the molten salt loop. The molten salt reactor vessel further includes a refueling system configured to introduce a solid fuel slug into the liquid molten fuel salt in the loop from an outer region outside the containment region.

In another example, the refueling system may include a chute having a pipe run extending between the outer region and the containment region. The containment region may be elevationally below the outer region.

In another example, the chute may include a first isolation valve within the containment region that is configured to fully close the pipe run. The chute may further include a second isolation valve arranged within the outer region and configured to fully close the pipe run.

In another example, the refueling system may include a fuel slug loading assembly having an inert chamber with an entry port therein. The entry port may be configured to receive a solid fuel slug therein and direct the solid fuel slug toward the pipe run. The refueling system may further include a terminal sieve fluidically coupled with the pipe run opposite the entry port that is configured to receive the solid fuel slug via the pipe run. The terminal sieve may be positionable with the liquid molten fuel salt for dissolution of the solid fuel slug therein.

In another example, the terminal sieve may be positioned in the reactor access vessel.

In another example, a method of refueling a molten salt reactor system is disclosed. The method includes loading a solid fuel slug into a fuel slug loading assembly of a refueling system. The method further includes inserting the solid fuel slug into an entry port arranged within an inert chamber of the fuel slug loading assembly. The method further includes causing the solid fuel slug to drop through a chute of the fuel loading assembly. The chute extends from the entry port and elevationally below the inert chamber. The method further includes receiving the solid fuel slug at a terminal sieve of the refueling system. The terminal sieve is positioned at an end of the pipe run opposite the entry port. The method further includes causing the solid fuel salt held within the terminal sieve to dissolve into a liquid molten fuel salt.

In another example, the method further includes circulating the liquid molten fuel salt through a molten salt loop. The molten salt loop may include a reactor vessel, a reactor access vessel, a reactor pump, and a heat exchanger.

In another example, the causing of the fuel salt to dissolve may further include causing entry of the liquid molten fuel salt into a series of perforated slits of the terminal sieve.

In another example, the method may further include operating a fuel slug loading assembly by arranging the solid fuel slug on a loading door, and selectively closing the loading door to encourage entry of the solid fuel slug into the entry port.

In another example, the method may further include storing one or both of the solid fuel slug or constituent components thereof proximal the fuel slug loading assembly. The method may further include preparing the solid fuel slug for entrance into the entry port.

In addition to the example aspects described above, further aspects and examples will become apparent by reference to the drawings and by study of the following description.

### BRIEF DESCRIPTION OF THE DRAWINGS

FIG. 1 depicts an example molten salt reactor system.

FIG. 2 depicts an example refueling system of the molten salt reactor system of FIG. 1.

FIG. 3 depicts another example refueling system.

FIG. 4 depicts a terminal sieve of the refueling system of FIG. 3 disposed within a vessel.

FIG. 5 depicts detail 5-5 of FIG. 4

FIG. 6 depicts detail 6-6 of FIG. 5.

FIG. 7 depicts an example fuel slug loading assembly of the present disclosure.

FIG. 8 depicts a flow diagram of a method of refueling a molten salt reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a loading apparatus and system for a molten salt nuclear reactor or MSR. MSRs may include a collection of components configured to circulate a molten fuel salt along a fuel salt loop. MSRs may also include a collection of components configured to circulate a secondary salt or coolant along a coolant salt loop. For example, a molten salt reactor system may operate by circulating a molten fuel salt between a reactor vessel (within which fission occurs) and a heat exchanger (for the removal of heat from the fuel salt). As another example, a molten salt reactor system may operate by circulating a secondary salt between the heat exchanger (for heat transfer from the molten fuel salt to the secondary salt), and a radiator (too cool the secondary salt). A uranium or other fissionable material is mixed with a carrier salt to create the fuel salt. The secondary salt may be a carrier salt void of fissionable material. In one example, the composition of the fuel salt may be LiF—BeF₂—UF₄, though other compositions of fuel salts may be utilized. In one example, the composition of the secondary salt may be LiF—BeF₂, though other compositions of secondary salts may be utilized. Upon shutdown of the molten salt reactor system, it may be necessary to remove the molten fuel salt from the fuel salt loop, such as removing the fuel salt from the reactor vessel, heat exchanger and other associated components of the system. In this regard, example molten salt reactor systems may include a drain tank or other vessel or receptacle elevationally below the fuel salt loop that is configured for receiving a gravitational flow of the fuel salt upon shutdown. Similarly, it may be necessary to remove the secondary salt from the coolant salt loop, such as removing the secondary salt from the heat exchanger, radiator and other associated components of the system. In this regard, the example molten salt reactor system may further include a secondary salt drain tank or other vessel or receptacle elevationally below the coolant salt loop that is configured for receiving a gravitational flow of the secondary salt upon shutdown.

Over the course of operation of the MSR, it may be desirable to change, adjust or otherwise alter a composition of the fuel salt or secondary salt. For example, as fission reactions occur over the lifecycle of the MSR, the chemical composition of the fuel salt may change or degrade, which, among other hinderances, could reduce the efficiency of the MSR. As another example, the change in the composition of the fuel salt or secondary salt over time may influence the corrosivity of the salt in the system (i.e., the fuel salt loop or the coolant salt loop). A solid powder, metal slug, or other solid composition can be added to the molten salt from time to time to adjust the properties of the molten salt. Such a solid powder, metal slug, or other solid may include fissile material (e.g., UF₄) where addition is made to the fuel salt loop. For clarity, as used herein “molten salt” refers to either molten fuel salt (i.e., containing fissile material) or secondary molten salt (i.e., not containing fissile material). However, despite the benefit of altering the composition of the molten salt, it may be impractical or burdensome to do so while the MSR is in operation due to radioactivity, heat, and/other hazards of the MSR. Moreover, the MSR may not be readily shut down or placed in a non-circulating configuration because doing so would require the MSR to transition the molten salt to a subcritical (solid) state in which the MSR ceases to generate heat from fission reactors. And even where the MSR is shut down and placed in a non-circulating configuration, the molten salt of the MSR would revert to a solid form, held in the drain tank, and as such, the molten salt would not be readily mixable or modifiable by the addition of solid fuel thereto.

To mitigate these and other deficiencies, the loading apparatus and systems of the present disclosure may facilitate the introduction of a solid slug (e.g., a slug including UF₄, other fissile material, and/or other molten salt composition altering component, which may be in powder or cake form) into a liquid molten salt. The liquid molten salt may be an active flow through the molten salt loop of the MSR (i.e., the fuel salt loop or coolant salt loop). The liquid molten salt may be in a static vessel filled with liquid molten salt (e.g., a static mixing vessel, processing vessel, or any other vessel of the reactor system). For example, the flow may be a segment of the molten salt loop that is circulated between a reactor core (where fission occurs) and a heat exchanger (where heat is extracted from the molten salt). As another example, the flow may be a segment of the molten salt coolant loop that is circulated between the heat exchanger (where heat is transferred from the fuel salt to the secondary salt) and a radiator (where heat is expelled from the secondary salt). As yet another example, the liquid molten salt may be static within a static or processing vessel. The refueling apparatus and systems described herein may provide for the introduction of the solid slug while the MSR is fully operational, and the molten salt is in a substantially liquid state. In this regard, the composition of the molten salt can be adjusted in substantially real time, while the reactor is in operation, and without requiring any shut down or other procedures that would otherwise interrupt the normal operations of the MSR. In some embodiments, the liquid molten salt may be agitated (e.g., via bubbles, stirring, etc.) to encourage dissolution.

However, as will be understood by one of ordinary skill in the art, the loading apparatus and systems of the present disclosure may be employed in systems other than an MSR. In this regard, the loading apparatus and systems of the present disclosure may be employed where an inert environment is required and where the release of the process fluid posses a threat to humans. For example, the loading apparatus and systems of the present disclosure may be employed where the material to be included (i.e., slug) is a solid material, where the process material (e.g., molten salt) is a fluid, where maintenance of an inert environment is required or otherwise desirable, and/or where the release of the process fluid poses a threat to humans or where contact is otherwise undesirable. As such, the following discussion relates to merely one example implementation of the apparatuses and systems of the present disclosure.

To facilitate the foregoing, a refueling system is disclosed herein including a slug loading assembly, a chute, and a terminal sieve. The slug loading assembly may generally be arranged elevationally above the reactor core and include an inert chamber at which the slug is prepared and received by the loading system. In some cases, the slug loading assembly may further include an entry mechanism that permits the selective entry of the slug into the loading system, as described further herein. The chute may include a pipe run that extends from the inert chamber and elevationally below the slug loading assembly, and generally toward the reactor core or a salt-bearing vessel of the coolant salt loop (e.g., surge tank). The chute may pass through and provide a passage through multiple containment barriers of the MSR enroute to the reactor, including through an outer containment (concrete) barrier and one or more enclosures, including shielding. The chute may further include one or more controls disposed thereon that fluidically isolate the slug loading assembly from the reactor. For example, the chute may progress until it reaches the terminal sieve which is arranged within a reactor access vessel of the MSR, and along a flow path of the molten salt of the molten salt loop. However, the terminal sieve may be arranged within any vessel of the MSR, for example, a reactor access vessel, processing vessel, or other static vessel. As another example, the chute may progress until it reaches the terminal sieve which is arranged with a vessel of the coolant salt loop of the MSR, and along a flow path of the molten salt of the molten coolant salt loop. As described herein, the reactor access vessel of the MSR is used as simply one example location of the terminal sieve and destination of the solid slug; however, the present disclosure also contemplates vessels within the coolant salt loop, such as a surge tank, as the location of the terminal sieve and destination of the solid slug. Stated otherwise, the various assemblies and systems of the present disclose may be adapted for input of solid slugs into the molten fuel salt loop (i.e., a solid fuel slug) or the molten coolant salt loop (i.e., a solid slug without fuel).

The terminal sieve may be fluidically coupled with the pipe run of the chute (opposite the fuel slug loading assembly) and be configured to receive the solid slug therein. For example, in some cases, the solid slug introduced to the chute at the slug loading assembly may proceed through the pipe run via gravity; in other cases, pneumatics, pressure differentials, and/or other mechanisms may be employed to move the solid slug to the terminal sieve. In several embodiments, the terminal sieve is positioned within the reactor access vessel and in a flow of the molten fuel salt or a stagnant body of molten fuel salt of the molten salt loop. However, the terminal sieve may be positioned within any vessel along the molten salt loop (e.g., a chemical processing vessel, static mixing vessel, etc.). In other embodiments, the terminal sieve is positioned within a vessel of the coolant salt loop and in a flow of the secondary salt or a stagnant body of secondary salt of the coolant salt loop. The terminal sieve includes a series of perforated slits configured to receive said molten salt therein, which, upon entry into the terminal sieve, serves to dissolve the solid slug into the liquid salt. In some embodiments, the stagnant body of molten salt may be agitated (e.g., via bubbles, sparging, stirring, vibration, etc.) to encourage dissolution of the solid slug therein. The molten salt may correspondingly exit the terminal sieve having some portion of the solid slug dissolved therein, thereby altering a composition of the molten salt during operation of the MSR. Instrumentation may be employed to monitor the liquid molten salt such that additional quantities of the solid slug can be again added to the liquid molten salt, as needed. The solid slug may have a wide variety of compositions configured to alter the characteristics of the molten salt based on the need. For example, the solid slug may be a solid fuel slug comprising fissile material (e.g., UF₄). As another example, the solid slug may be a solid fuel slug comprising fissile material, a binding agent, and/or other components of the molten salt (e.g., Li, Be, F, etc.). As another example, the solid slug may be a metal beryllium slug. As another example, the solid slug may comprise lithium (e.g., LiF), beryllium (e.g., BeF₂), or a combination thereof. As yet another example, the solid slug may comprise a material or composition that absorb neutrons (e.g., ErF₃) to adjust reactor physics. In various embodiments, the terminal sieve may be a different configuration based on the material (i.e., solid slug) included therein. For example, the terminal sieve may have smaller (e.g., to accommodate LiF and BeF₂ slugs) or larger through portions (e.g., to accommodate UF₄ slugs) or perforated slits based on the composition of solid slug. Additionally or alternatively, the terminal sieve itself may be of different compositions to accommodate the particular solid slug composition used (e.g., to avoid unwarranted reaction).

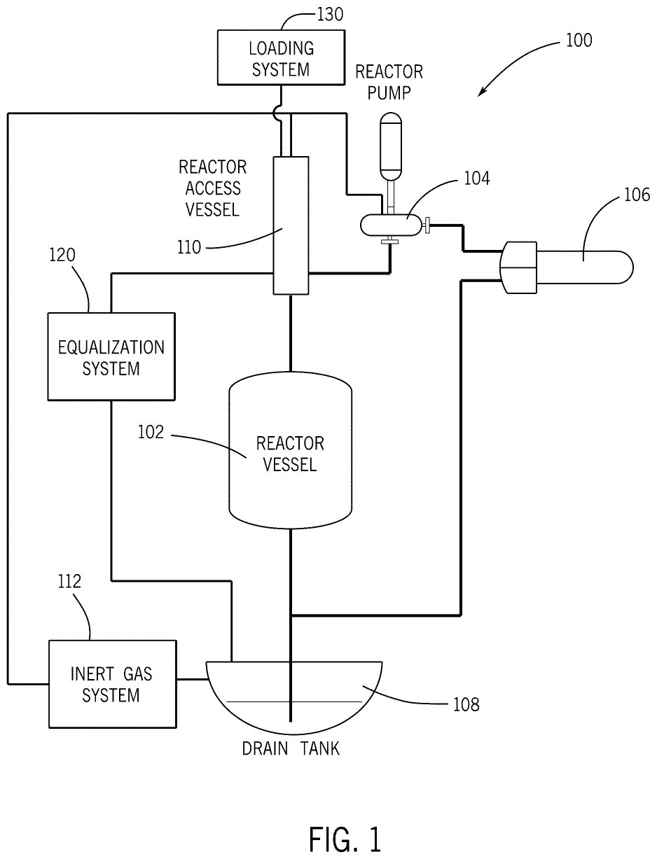

Turning to the drawings, for purposes of illustration, FIG. 1 depicts a schematic representation of an example molten salt reactor system 100. The molten salt reactor system 100 may implement and include the loading apparatus and system, and implement any of the functionalities of each described herein. As will be understood, the example shown in FIG. 1 represents merely one example configuration of a molten salt reactor system 100 in which a refueling apparatus and systems may be utilized. It will be understood that the loading apparatus and systems described herein may be used in and with substantially any other configuration of the molten salt reactor, as contemplated herein. For example, the loading apparatus and systems described herein may be used in conjunction with the heat removal system (i.e., coolant salt loop) of the molten salt reactor system.

In various embodiments, a molten salt reactor system 100 utilizes fuel salt enriched with uranium (e.g., high-assay low-enriched uranium) to create thermal power via nuclear fission reactions. In at least one embodiment, the composition of the fuel salt may be LiF—BeF₂—UF₄, though other compositions of fuel salts may be utilized as fuel salts within the reactor system 100. The fuel salt within the system 100 is heated to high temperatures (about 600° C. or higher) and melts as the system 100 is heated. In several embodiments, the molten salt reactor system 100 includes a reactor vessel 102 where the nuclear reactions occur within the molten fuel salt, a fuel salt pump 104 that pumps the molten fuel salt to a heat exchanger 106, such that the molten fuel salt re-enters the reactor vessel after flowing through the heat exchanger, and piping in between each component. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also acts as storage for the fuel salt if power is lost in the system 100. The reactor access vessel may be configured to allow for introduction of small pellets of uranium fluoride (UF₄) to the system 100 as necessary to bring the reactor to a critical state and compensate for depletion of fissile material.

For example, a loading system 130 is shown in FIG. 1 that may be generally used to provide such pellets or a solid slug to the molten salt loop of the system 100. Broadly, and as described in greater detail herein, the loading system 130 (sometimes referred to as a refueling system 130) may include all appropriate components, assemblies, and subsystem as needed to prepare and/or receive a solid slug (e.g., a slug, including UF₄ and/or other fissile material, a slug including other molten salt characteristic altering compounds such as BeF₂, LiF, or a slug including neutron absorbing materials such as ErF₃, etc.) and to transfer such material to the liquid molten salt. As shown in FIG. 1, the loading system 130 may, in one example, be operatively coupled to the reactor access vessel 110 such that the solid fuel slug is provided to the molten salt loop via the reactor access vessel 110; however, in other cases, the solid slug may be introduced to other vessels of the molten salt loop including those having active flows or stagnant bodies of the molten salt loop. In still other cases, the solid slug may be introduced to the flow of a coolant salt loop or a stagnant body of the coolant salt of the molten salt reactor system 100. Once the solid slug is arranged within the liquid molten salt (e.g., arranged within the reactor access vessel 110), the solid slug may be dissolved by and into the liquid molten salt, thereby altering a composition of the liquid molten salt. The foregoing operation may occur while the system 100 remains in operation (e.g., while fission reactions continue in the reactor vessel 102), and may occur additionally as needed over the operational lifecycle of the molten salt to continuously adjust the composition of the liquid molten salt, as needed.

In several examples, the molten salt reactor system 100 may include an inert gas system 112 to provide inert gas to a head space of the drain tank 108, among other functions. The inert gas system 112 may further relieve inert gas from the head space of the drain tank 108 as needed. The inert gas system 112 is therefore operable to maintain pressurized inert gas in the head space of the drain tank 108 that is sufficient to substantially prevent the flow of molten fuel salt into the drain tank during normal operations. For example, with the head space of the drain tank 108 pressurized by the inert gas system 112, molten salt may generally circulate between the reactor vessel 102 and the heat exchanger 106 without substantially draining into the drain tank 108. As described herein, the inert gas system 112 may be configured to supply inert gas to the head space of various other components of the molten salt reactor system 100, such as to the head space of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas.

The molten salt reactor system 100 may further include an equalization system 120 that is operable to equalize the pressure among all headspace of the system 100, including, without limitation, the head space of the drain tank 108 and the reactor vessel 102 upon the occurrence of a shutdown event. For example, during normal operation, a pressure differential exists between the head space of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event. As described in greater detail herein, the equalization system 120 may include numerous redundances and/or bypasses in order to facilitate a fail-safe or walk-away safe operation with respect to depressurization of the system 100.

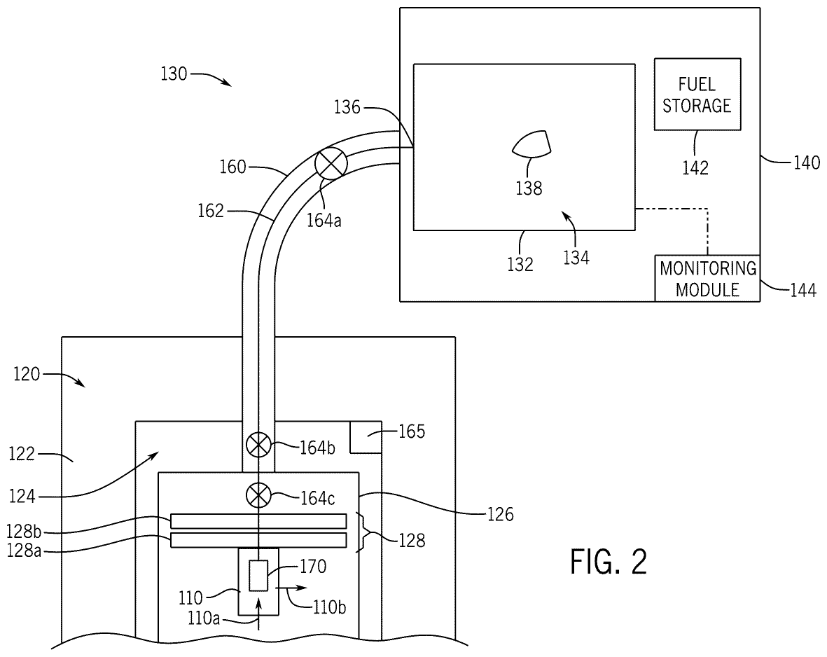

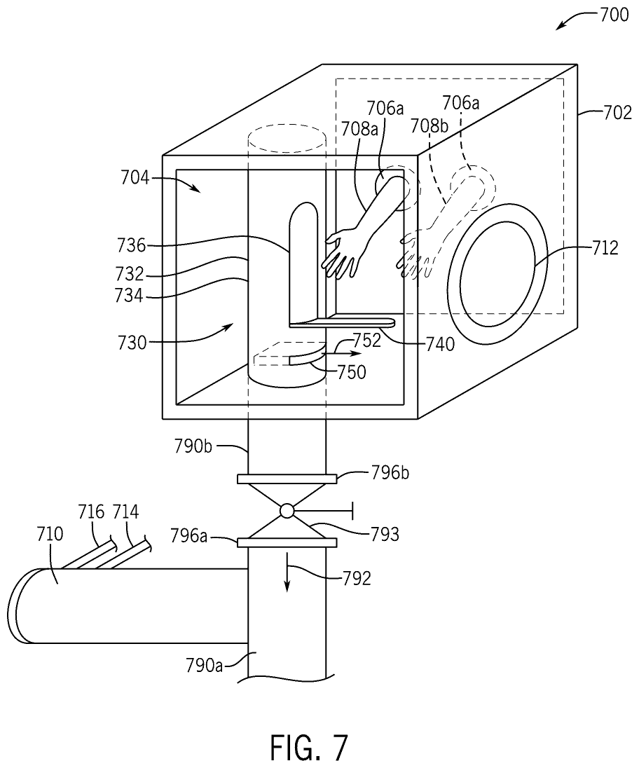

It will be appreciated that the loading system 130 may include any of a variety of appropriate collections of mechanical components, instruments, controls, and so on in order to perform the functions described herein. With reference to FIG. 2, example components of the loading system 130 are depicted for purposes of illustration, including a slug loading assembly 132, a chute 160, and a terminal sieve 170. The slug loading assembly 132 may include all manner of components as may be needed or desired to prepare and/or receive the solid slug 138 into the refueling system 130. For example, the solid slug 138 may include a wide variety of salt altering compounds, such as but not limited to UF₄, Li, Be, any combination thereof, or other salt altering compounds based on the need. More broadly, the slug loading assembly 132 may be arranged within an outer region 140 that is a region separated from (and optionally elevationally above) the reactor core and/or other critical components of the system 100. More broadly still, the slug loading assembly 132 may be arrange within an outer region 140 that is a region separated form (and optionally elevationally above) a vessel of a coolant salt loop of the system 100. The outer region 140 may therefore be positioned sufficiently far from the reactor core or other component such that personnel may interact with the slug loading assembly 132 and engage in the associated tasks of preparing the solid slug therein. In this regard, the outer region 140 is shown, schematically in FIG. 2, as including the slug loading assembly 132 and the fuel storage 142. The slug loading assembly 132 may define an inert chamber 134 having a solid slug 132 therein. In operation, personnel may access the fuel storage 142, which may include any of a variety of constituent components for forming the solid slug 132, and for preparing and assembling the solid slug 138 within the inert chamber 134. For example, and as described in greater detail herein in relation to FIG. 7, the inert chamber 134 may include or be associated with a glove box and/or a vacuum chamber such any solid fuel slug preparation activities may occur in such inert environment, and within an established barrier between the fuel slug and the personnel. The outer region 140 and/or the loading assembly 132 may further include one or more monitoring module(s) 144 configured to monitor various parameters associated with the preparation of the slug 138, including, but not limited to radiation levels, temperature, pressure, and oxygen composition of gasses in contact with the slug 138, among other parameters. Accordingly, the loading system 130 may operate to satisfy various relevant principal design criteria of the Nuclear Regulatory Commission, such as criterion 63, among others. In some cases, monitoring module(s) 165, having similar functionality, may be arranged proximal the reactor, such as with the containment region 124, as one example. In this regard, the slug loading assembly 132 may be configured to (1) to detect conditions that may result in loss of temperature control capability and excessive radiation levels and (2) to initiate appropriate safety actions. For example, at least the monitoring module(s) 144 may be used to monitor for deviations from technical specifications and take appropriate remedial actions.

The slug loading assembly 132 may therefore be configured to support fuel storage, handling, and radioactive control. For example, the slug loading assembly 132 may be configured to assure adequate safety under normal and postulated accident conditions. Further, the slug loading assembly 132 may be configured to and designed (1) with a capability to permit appropriate periodic inspection and testing of safety related systems, (2) with suitable shielding for radiation protection, (3) with appropriate containment, confinement, and filtering systems, (4) with a passive residual heat removal capability having reliability and testability that reflects safety related the importance to safety of temperature control, and (5) to prevent significant reduction in fuel storage cooling under accident conditions. Furthermore, fresh UF₄ (e.g., the material used to form the slug 138, in one example) emits relatively little radiation and produces almost not heat (prior to use), so it may be readily stored and contained by the glove boxes described herein. For example, oxygen may be kept away from the UF₄, and the monitoring module 144 may operate to promote a stable and inert environment for the UF₄ during said storage. Accordingly, the refueling system 130 may operate to satisfy various relevant principal design criteria of the Nuclear Regulatory Commission, such as criterion 61, among others.

Additionally or alternatively, the slug loading assembly 132 may be configured to prevent the criticality of the fuel in storage and handling thereof. For example, the slug loading assembly 132 may be configured to prevent criticality in the fuel storage and handling systems and process, including by geometrically safe configurations. In one instance, the slug loading assembly 132 may accomplish such functionality by physically separating the slug 138 and the graphite moderator. To illustrate, without a moderator, UF₄ cannot generally become critical due to the low inventory being stored. A moderator is a material which slows down or thermalizes neutrons which makes them more likely to fission. Graphite in the MSR core is a moderator, water is used in other reactors. The loading system is designed so that large volumes of water cannot intrude. Accordingly, the loading system 130 may operate to satisfy various relevant principal design criteria of the Nuclear Regulatory Commission, such as criterion 62, among others.

The slug loading assembly 132 is shown associated with the chute 160. The chute 160 may include a pipe run or slug path 162 that extends from an entry port 136 of the fuel slug loading assembly 132, to a position elevationally below and toward the reactor core, for example. The internal pipe run or slug path 162 acts as a carrier of the slug 138, and the outer chute 160 acts as a containment barrier encompassing the internal pipe run. In this regard, the outer chute 160 operates to protect the internal pipe run held therein. As shown schematically in FIG. 2, the slug path 162 may include one or more control and/or isolation valves, such as the example valves 164a, 164b, 164c shown in FIG. 2 (in some cases, more or fewer valves may be used). The slug path 162 may be defined by a single-walled or a double-wall pipe that forms the chute 160 in a manner that permits that gravitational flow of the solid slug therethrough and to the reactor core and access vessel below. In this regard, and as shown in FIG. 2, the chute 160 may progress through multiple layers of containment, vessels, shielding, and/or other barriers that stand between the reactor core, access vessel, coolant salt loop vessel and an external environment. In some cases, the chute 160 may define an inert environment about the internal pipe run or slug path 162, and include an inert gas therein, such as a helium or nitrogen gas at ambient conditions.

By way of example, FIG. 2 shows the chute 160 extending from the outer region 140 and through a reactor cell 120 (which may be an outermost concrete barrier of the reactor) and ending at a reactor enclosure 126. The internal pipe run or slug path 162, in turn is shown extending from the slug loading assembly 132, through an outer wall of the outer region 140 (and into the chute 160), through the reactor cell 120, through the reactor enclosure 126, through a reactor thermal management system vessel 128 (including optional shielding 128a and insulation 128b), and through the reactor access vessel 110. In other examples, the chute 160/internal pipe run may extend through more or fewer layers. Further, the reactor cell 120, as the outer most barrier, may generally define a containment region 124 within which the chute 160 enters. At least one of the valves (e.g., such as valve 164b, 164c) of the chute 160 may be arranged within the containment region 124. Accordingly, the flow path 162 may be isolated at a position from within the containment region 124 (e.g., by valves 164b, 164c) and a position from outside of the containment region 124 (e.g., by valve 164a), which may be in or otherwise associated with the outer region 140). By isolating the flow path 162 both inside and outside of the containment region 124, the loading system 130 can maintain physical isolation between the liquid molten salt of the reactor loop (i.e., molten fuel salt loop and/or coolant salt loop) and the inert environment of the inert chamber 134 at all times. For example, the valves 164a, 164b, 164c may be typically closed, and then opened and closed in series, as the solid slug 138 reaches each respective valve, thereby ensuring that at least one of the valves 164a, 164b, 164c remains closed at any given point during the progression of the solid slug along the chute 160 to support the isolation of the outer region 140 from the liquid molten salt of the containment region 124. Accordingly, the isolation valves under normal circumstances may prevent fission product gasses from the reactor from escaping up through the chute 160 and/or the fuel flow path 162. In turn, when the valves are open (e.g., to drop the fuel slug 138), the fuel flow path 162 represents a first fission product barrier, and the outer chute 160 represents a second outer fission product barrier, for example, as the outer chute 160 is sealed with respect to the glove box 132 and the inner pipe hatch to the glove box 132 shall remain closed during such operation.

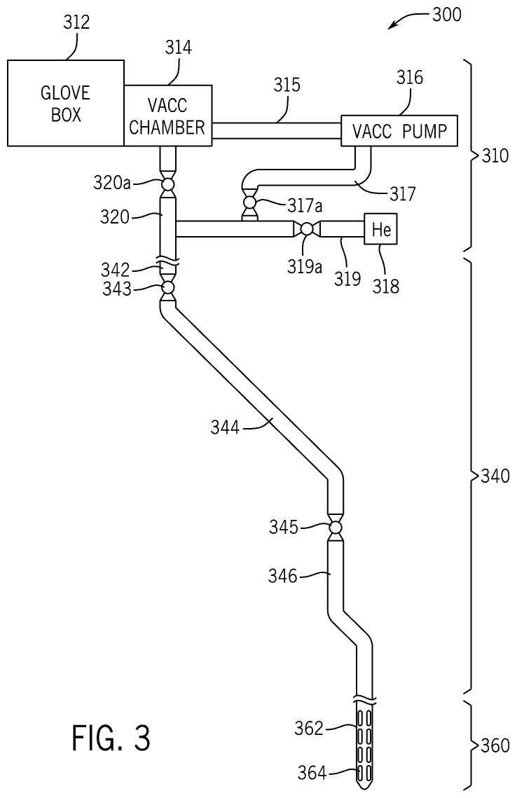

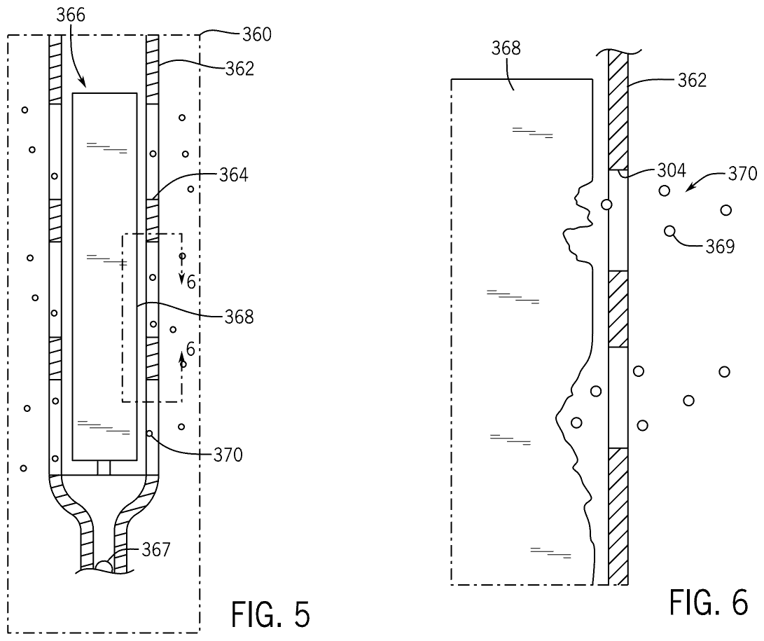

Finally, as depicted in FIG. 2, the internal pipe run or slug path 162 may end at, and be fluidically coupled to, the terminal sieve 170, which is positioned inside of the reactor access vessel 110. In some embodiments, vessel 110 is a static mixing vessel, processing vessel or other vessel within the reactor cell 120. The terminal sieve 170 may be disposed within the reactor access vessel 110 and in the liquid molten fuel salt of the reactor system. In some embodiments, the terminal sieve 170 may be disposed within a vessel of the coolant salt loop, such as a surge tank or piping between the heat exchanger 104 and a radiator, and in the liquid coolant salt of the reactor system. For example, the reactor access vessel 110 may generally receive an inlet flow 110a of liquid molten salt from the reactor vessel 102, and may output an output flow 110b of liquid molten salt therefrom. The terminal sieve 170 may be positioned with the liquid molten salt such that the terminal sieve 170 receives at least some of the molten salt from the inlet flow 110a, and may be further positioned such that at least some of the liquid molten salt of the outlet flow 110b has interacted with the terminal sieve 170. The terminal sieve 170 may be configured to receive the solid slug 138 therein, and may include a series of perforated slits (as shown in greater detail with reference to FIG. 3) that permit the introduction of liquid molten salt therein and out from. Accordingly, and described in greater detail herein in reference to FIGS. 5 and 6, the liquid molten salt from the inlet flow 110a may be received by the terminal sieve 170 and interact with and dissolve at least some of the solid slug 138 therein. Having the solid slug 138 dissolved therein, a least a portion of the liquid molten salt of the terminal sieve 170 may exit the terminal sieve and proceed into and combine with the outlet flow 110b. The dissolution of the solid slug 138 into the liquid molten salt may cause one or more properties of the liquid molten salt to change, with such change occurring while said molten salt is engaged in the molten salt loop including undergoing fission reactions within the reactor vessel 102. The loading system 130 may therefore operate to introduce the solid slug 138 into the continuous stream of liquid molten salt, without shutting down or otherwise hindering the ongoing operations of the reactor system 100. Furthermore, the loading system 130 may accomplish the foregoing while maintaining at least two barriers around the slug 138 separating the slug 138 from the atmosphere and two barriers protecting the reactor head space (e.g., gas in contact with the fuel salt in the reactor access vessel 110) from escaping to the environment. Accordingly, the loading system 130 may operate to satisfy various relevant principal design criteria of the Nuclear Regulatory Commission, such as criterion 55, among others.

With reference to FIG. 3, another example loading system is shown, a loading system 300. The loading system 300 may be substantially analogous to the loading system 130 described above in relation to FIGS. 1 and 2, and include a slug loading assembly 310, a chute 340, and a terminal sieve 360 each of which may utilize double-walled pipe or pipe held in a protective chute; redundant explanation of which is omitted herein for clarity. Notwithstanding the foregoing similarities, in the example of FIG. 3, the slug loading assembly 310 is shown as including various additional components to facilitate the preparation and/or loading of a solid slug into the loading system 300, including a glove box 312, a vacuum chamber 314, a vacuum pump 316, and an inert gas source 318. The glove box 312 may be operable to receive various components associated with the preparation of the solid slug (e.g., a slug including UF₄ and/or other fissile materials or a slug including other salt characteristic modifying compounds). The glove box 312 may be positioned sufficiently away from any reactor core or other critical component such that personnel may engage with and manipulate any materials held within the glove box 312. The vacuum chamber 314 may be operable to establish an inert gas vacuum both within the glove box 312 and throughout the chute 160, terminal sieve 360 and/or other components of the loading system 300.

To facilitate the foregoing, the inert gas source 318 (which may include a helium gas) may actively provide inert gas to the loading system 300 via a pipe segment 319, as may be controlled by control valve 319a. The pipe segment 319 may be fluidically coupled with a pipe segment 320 (which extends into the vacuum chamber 314 and is selectively isolated via a control valve 320a), and with a pipe segment 317 (which extend into the vacuum pump 316 and is selectively closeable via a control valve 317a). The vacuum chamber 314 and the vacuum pump 316 may be further fluidically coupled via a pipe segment 315. In operation, the vacuum pump 316 may function to draw a vacuum in the vacuum chamber 314 and associated fluidically coupled piping segments in order to define the environment therein as being filled with an inert gas (e.g., from the inert gas source 318), held under vacuum. The inert gas environment may permit the solid slug to be surrounded by an environment that does not spoil the slug or otherwise alter the properties of the slug prior to the introduction of the slug into the molten salt. And further, by being held under vacuum, the solid slug can more readily transfer from the vacuum chamber 314 to the components of the chute 340 and toward the terminal sieve 360, as described herein.

With respect to the chute 340, generally any variety of components, piping segments, valves, and so on may be used in order to define a flow path for the fuel slug between the slug loading assembly 310 and the terminal sieve 360. Generally, the chute 340 may include multiple pipes that are sufficiently long enough to permit the slug loading assembly 310 to be positioned elevationally above the reactor core, and outside of the containment of the reactor so that personnel can access the slug loading assembly without exposure to the radioactivity, heat, and/or other hazards associated with the reactor core or other critical component. In this regard, in the example of FIG. 3, a first chute pipe segment 342, a second chute pipe segment 344, and a third chute pipe segment 346 are shown, arranged in series with one another. The first chute pipe segment 342 may be fluidically coupled with the second chute pipe segment 344 via a control valve 343. The second chute pipe segment 344 may be fluidically coupled with the third chute pipe segment 344 via a control valve 345. The third chute pipe segment 346 may be further fluidically coupled with the terminal sieve 360, opposite the second chute pipe segment 344. Each of the pipe segments 342, 344, 346 (and/or any of the pipe segments described herein) may be constructed with withstand the heat and corrosivity conditions brough on by a liquid molten salt, including being constructed from material capable of withstanding temperatures of greater than 500° C., withstanding temperature of greater than 600° C., withstanding temperature of greater than 700° C., or greater. In this regard, such pipe segments may be constructed from a stainless steel material. In some cases, one or more or all of such pipe segments may be constructed as a doubled-walled pipe. In some embodiments, the position of the solid slug may be tracked as it proceeds through the chute pipe segments 342, 344, 346. For example, position indicators (e.g., lasers) may be placed along the chute pipe segments 342, 344, 346 operable to notify an operator that the solid slug has reach a position associated with the position indicators. For example, each control valve (i.e., control valve 320a, 343, 345) may include a position indicator or a position indicator may be disposed proximal to each control valve (e.g., right above control valves 320a, 343, 345).

The chute 340 may, collectively, extend from the slug loading assembly 310 to the terminal sieve 360. In this regard, the chute 340 my extend from an outer region at which the slug loading assembly 310 is disposed to a containment region at which the terminal sieve 360 is disposed. Because the chute 340 defines a fluidic connection between the outer region and the containment region through which the solid slug travels, the chute 340 may include multiple control valves in order to maintain isolation of the containment region from the outer region such that the outer region need not be opened or exposed to the containment region. To facilitate the foregoing, at least one control valve (e.g., control valve 343) may be arranged in the outer region (adjacent to the fuel slug loading assembly), and at least another control valve (e.g., control valve 345) may be arranged in the containment region (adjacent to the terminal sieve 360). In operation, the slug may enter the chute 340 at the pipe segment 342, and the control valve 343 may be actuated to open and allow the slug to travel into the pipe segment 344. The slug may travel into the pipe segment 344 while the control valve 345 remains closed, and thereby the containment region remains isolated form the outer region. Subsequently, the control valve 343 may close, and upon confirmation of the same, the control valve 345 may be actuated to open and allow the slug to travel into the pipe segment 346 and toward the terminal sieve 360. The slug may travel into the pipe segment 346 while the control valve 343 remains closed, and thereby the containment region remains isolated from the outer region. By executing the foregoing process in series, the chute 340 is capable of establishing a pathway for the solid slug to travel to the terminal sieve 360 while also maintaining an isolation between the containment region and the outer region at all times.

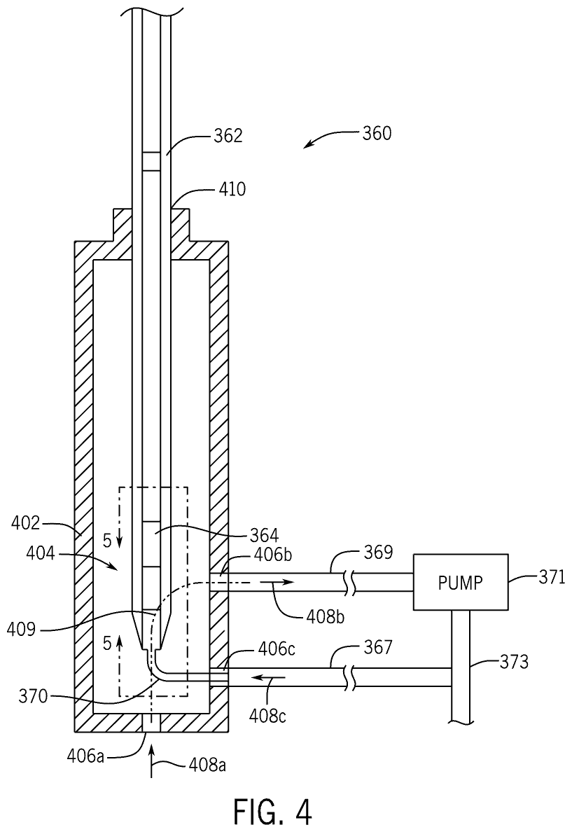

With respect to the terminal sieve 360, the solid slug is received by the terminal sieve 360 at the end of the pipe segment 346 (or any other pipe segment defining an end of the chute 340). The terminal sieve 360, as shown in FIG. 3, may generally include a tube 362 and perforated slits 364. The tube 362 may be configured to remain in place within a constant flow of a liquid molten salt solution, and may therefore be constructed in a manner similar to the pipe segments 342, 344, 346 described above. In some embodiments, tube 362 is configured to remain in place within a stagnant body of liquid molten salt solution. The perforated slits 364 may be openings or through portions defined through a thickness of the tube 362. The perforated slits 364 may be sufficiently small in order to prevent the release of the solid slug from the terminal sieve 360 upon entry of the slug into the tube 362. Notwithstanding, the perforated slits 364 may be sufficiently large enough in order to permit a flow of liquid molten salt from the molten salt loop to enter the tube 362 and dissolve at least a portion of the solid slug therein, for example, as shown herein in reference to FIGS. 4-6. Terminal sieve 360 may be configured with smaller or larger perforated slits 364 to accommodate different slug compositions. For example, larger perforated slits 364 may be used for a UF₄ solid slug while smaller perforated slits 364 may be used for LiF and BeF₂ solid slugs. Additionally or alternatively, terminal sieve 360 may be formed of different compositions based on the particular composition of solid slug used (e.g., in order to avoid unwarranted reaction).

In various embodiments, the terminal sieve is disposed within a vessel of an MSR system (e.g., reactor access vessel). In these embodiments, the solid slug is a solid fuel slug comprising fissionable material (e.g., UF₄) and may be input into molten fuel salt. With reference to FIG. 4, the terminal sieve 360 is shown disposed within a reactor access vessel 402. However, in other embodiments, vessel 402 is a processing vessel, static mixing vessel, or other vessel coupled to the molten salt loop of the MSR system. The reactor access vessel 402 may be substantially analogous to the reactor access vessel 110 described in relation to FIG. 1, and include a liquid fuel salt inlet 406a that is configured to receive a liquid molten salt inflow 408a, and may further include a liquid fuel salt outlet 406b that is configured to emit a liquid molten salt outflow 408b. The liquid molten salt may generally proceed through a reactor access vessel volume 404 along a flow segment 409 (“refueling flow segment” or “refueling segment”) from the salt inflow 408a to the salt outflow 408b. The terminal sieve 460 may be arranged directly in the flow segment 409 such that at least a portion of the liquid molten salt of the flow segment enters the tube 362 via the perforated slits 364 of the terminal sieve 360. While FIG. 4 illustrates a moving flow of liquid molten salt, one of ordinary skill in the art will appreciate that the terminal sieve 360 (and consequently the solid slug) may be disposed in vessels of the MSR system that include a stagnant or relatively stagnant body of liquid molten salt. In this regard, while the solid slug may be slower to dissolved, such dissolution may simply occur over a longer period of time, which may be desirable based on the need. Such embodiments are contemplated herein.

For example, and with reference to FIGS. 5 and 6, a solid fuel slug 368 may be arranged in a tube volume 366 of the tube 362 that defines the terminal sieve 360. The flow 409, including molten salt 370, may proceed into the tube volume 366 via the perforated slits 364 for dissolution of the solid fuel slug 368 therein. The flow 409 may continue to interact with the solid fuel slug 368 such that dissolved fuel 369 (show schematically in FIG. 6) breaks off of and dissolves with the flow of molten salt 370. In order to facilitate the dissolution of the solid fuel slug 368, the terminal sieve 360 may include or otherwise be associated with a dilution passage 367 fluidically coupled to a discharge of a pump (e.g., reactor pump 104), as shown in FIG. 4.

The dilution passage 367 may be generally configured to input a flow of molten salt directly into the terminal sieve 360 from the discharge of a fuel salt circulating pump, in order to encourage dissolution of the solid slug or solid fuel slug 368. To facilitate the foregoing, the dilution passage 367 may include or be a tube or other piping that is fluidically coupled with the tube volume 366 and a discharge pipe 373 of circulation pump 371 (or other pressurized molten salt flow segment of the MSR system). The dilution passage 367 may operate to circulate a flow 408c of liquid molten salt associated with the discharge pipe 373 to facilitate molten salt flow around the solid slug 368 within the terminal sieve 170. The provision of the flow 408c of liquid molten salt to the solid fuel slug 368 may promote the rapid dissolution of the solid fuel slug 368 into the molten salt flow 370. Flow 408c may exit the reactor access vessel 402 via flow 408b via piping 369 to various other components of the MSR system including, but not limited to, the circulation pump 371. While FIG. 4 shows the flow 408c entering the dilution passage 367, it will be appreciated that in other cases, the flow 408c may exit the dilution passage 367 depending on the arrangement of the system.

With reference to FIG. 7, one example slug loading assembly 700, is depicted for purposes of illustration. The slug loading assembly 700 may be substantially analogous to the slug loading assemblies 132 and 310 described above in relation to FIGS. 2 and 3, and may include a glove box 702, an inert volume 704, and a vacuum chamber 710; redundant explanation of which it omitted here for clarity. Notwithstanding the foregoing similarities, the fuel slug loading assembly 700 is shown as including further optional implementation details of the glove box 702, including hand ports 706a, 706b, gloves 708a, 708b, and an inert chamber entrance 712. Personnel may use the gloves 708a, 708b to manipulate any objects inside the inert chamber 704 (e.g., such as a solid fuel slug), while maintaining the inert environment therearound said objects. Isolation valve 793 may be included to fluidically isolate glove box 702 from chute 790a.

The glove box 702 is further shown as including an optional slug release apparatus 730. The slug release apparatus 730 may generally function to permit the selective entry of a solid slug into the loading system. For example, the slug release apparatus 730 may include one or more components that permits a solid slug to be introduced into the chute 790 in a controlled manner, and on the command of the personnel operating the glove box 702. In this regard, the slug release apparatus 730 is shown in FIG. 7 as including an entry mechanism 732 having an entry pipe portion 734 that defines an entry port 736. The entry port 736 may be configured to receive the solid slug therein, and may be fluidically coupled with pipe portion 790b and the chute 790a below. In some cases, the slug release apparatus 730 may further include a loading door 740 or other device that is operable to temporarily close the entry port 736 when not use. The loading door 740 may also optionally permit the arrangement of the fuel slug thereon when the loading door 740 is an open configuration. On closing of the loading door 740, the fuel slug arranged on the loading door 740 may slide correspondingly into the entry port 736 and toward the chute 790a.

The slug release apparatus 730 is further shown as including a release plate 750. The release plate 750 is insertable into the entry pipe portion 734 and may block an entirety of an interior flow path therethrough. The release plate 750, in turn, may be slidable out from the entry pipe portion 734 along a release direction 752 in order to at least partially remove the release plate 750 from the entry pipe portion 734 and to cease blocking the entirety of said interior flow path. The release plate 750 may therefore function as an additional control mechanism that operates to block the introduction of the solid slug into the pipe portion 790b and chute 790a until personnel actively pull the release plate 750 along the release direction 752. For example, when the release plate 750 is fully engaged in the entry pipe portion 734, any solid slug inserted into the entry port 736 may initially land on, and be blocked from progressing to pipe portion 790b and the chute 790 by, the release plate 750. On pulling of the release plate 750 along the release direction 752, the solid slug may cease to be blocked, and as such, the solid slug may proceed through pipe portion 790b and toward the chute 790a, and ultimately to the reactor access vessel below or other salt-bearing vessel below. The release plate 750 may therefore serve as an additional safety mechanism that requires personnel to take an additional affirmative action for any slug to be added to the system. In this regard, in some cases, the release plate 750 may be associated with a scale and/or other instruments or sensors that provide information concerning the contents of the solid slug that will be introduced into the system upon the pulling of the release plate 750. In other cases, other mechanisms may be included to support the selective release of the fuel slug to the system.

In several embodiments, the slug release apparatus 730 is removably attached to chute 790a, such that the entire glovebox 702 may be transported to and from chute 790a. In this regard, glovebox 702 (and all components associated therein) may be at an initial slug preparing location away from chute 790a where the slug may be initially prepared for inclusion to the MSR system and then may be subsequently transported (e.g., via wheeled cart, conveyor belt, vehicle, etc.) to chute 790a following preparations. To facilitate the foregoing, the slug release apparatus 730 may include or be fluidically coupled to a coupling mechanism. In several embodiments, the coupling mechanism comprises an isolation valve 793 interposed between a first attachment means 796a and a second attachment means 796b operable to selectively fluidically isolate chute 790a from entry pipe portion 734 and pipe portion 790b. In this regard, isolation valve 793 may be actuated to fluidically connect entry pipe portion 734 to chute 790a, thereby allowing a slug to be input into the reactor system via slug path 792. Additionally, isolation valve 793 may be actuated to fluidically isolate entry pipe portion 734 to chute 790a, prior to transportation of the slug release apparatus 730. In several embodiments, fist attachment means 796a is a flange configured to attach chute 790a to isolation valve 793 and second attachment means 796b is a flange configured to attach pipe portion 790b and/or entry pipe portion 734 to isolation valve 793 thereby establishing continuous slug path 792. In this regard, glovebox 702 may be placed on top of isolation valve 793 via alignment of pipe portion 790b and isolation valve 793. Thereafter, an operator may bolt or screw attachment means 796b and isolation valve 793 together. Thus, establishing a removeable connection between chute 790a and entry pipe portion 734.

In some embodiments, release plate 750 and/or entry pipe portion 734 may further be configured as the coupling mechanism operable to removable attach glovebox 702 to chute 790a. Additionally or alternatively, chute 790a may be equipped with an isolation valve 793 configured to fluidically isolate chute 790a from entry pipe portion 734. The coupling mechanism may include a variety of components to facilitate removable attachment, such as flanges, straps, fasteners, clamps, screws, bolts, and the like. For example, release plate 750 or entry pipe portion 734 may be equipped with a flange disposed on an underside of glovebox 702 configured to couple to a corresponding flange disposed on chute 790a. In this regard, glovebox 702 may be placed on top of chute 790a, via alignment of the release plate 750 flange and its corresponding flange. Thereafter, an operator may bolt, or screw said flanges together. Thus, establishing a removeable connection between chute 790a and entry pipe portion 734 interposed by release plate 750.

With continued reference to FIG. 7, the glove box 702 and chute 790a is further shown associated with a vacuum chamber 710, and associated gas lines 716, 714. As described in relation to FIG. 3, the vacuum chamber 710 may operate in connection with a vacuum pump and an inert gas source (not shown in FIG. 7) to provide inert gas to at least the chute 790a, and to maintain the chute 790a under vacuum. In this regard, the solid slug (upon release by the slug release apparatus 730), may proceed along the slug path 792 and toward the reactor access vessel or other salt-bearing vessel, and may generally encounter less air resistance, in view of the maintained vacuum therein. While the vacuum chamber 710 is shown as being elevationally below the slug release apparatus 730, it will be appreciated that such arrangement is for purposes of illustration. In other cases, the vacuum chamber 710 may be arranged elevationally above the slug release apparatus 730 or be elevationally aligned with the slug release apparatus 730, as may be appropriate for given configuration.

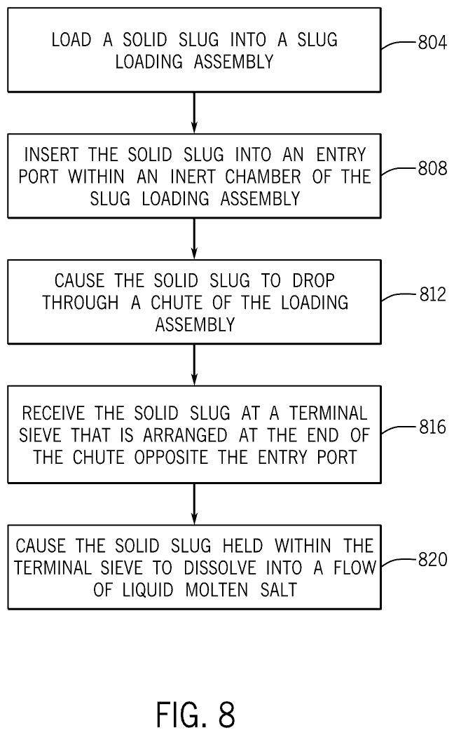

FIG. 8 depicts a flow diagram of a method 800 of loading a molten salt reactor system. At operation 804, a solid slug is loaded into a slug loading assembly. For example, and with reference to FIGS. 2 and 7, the solid slug 138 may be loaded into the slug loading assembly 132. For example, the solid slug 138 may be arranged within the glove box 702. In some cases, personnel may conduct one or more fuel slug preparation steps on the solid slug 138 while the fuel slug 138 is in the inert chamber 704.

At operation 808, the solid slug is inserted into an entry port within an inert chamber of the slug loading assembly. For example, and with continued reference to FIGS. 2 and 7, the solid slug 138 may be arranged to slide into the entry port 136. The entry port 136 may be fluidically coupled with the chute 160, such the solid slug 138 may be advanced to the chute 160 from the entry port 136. In some cases, the solid slug 138 may be optionally inserted into an entry port 736 using a slug release apparatus 730. For example, the solid slug 138 may be placed on the loading door 740 (when the loading door 740 is an open configuration), and may be slid into the entry port 736 (upon the gradual transitioning of the loading door 740 to a closed configuration).

At operation 812, the solid slug is caused to drop through a chute of the slug loading assembly. For example, and with reference to FIG. 2, the solid slug 138 may proceed into the chute 160 via the entry port 136. The chute 160 may include one or more isolation valves 164a, 164b, 164c along the slug path 162 toward the reactor access vessel 110 or other salt-bearing vessel. The solid slug 136 may proceed through the chute 160 upon the sequential opening and closing of such isolation valves 164a-164c. For example, and as described herein, the solid slug 138 may proceed from the outer region 140 upon the opening of the isolation valve 164a. Subsequently, the isolation valve 164a may be closed, and the solid slug 136 may proceed further toward and into the containment region 124 upon the opening of the isolation valves 164b, 164c, respectively.

At operation 816, the solid slug is received at the terminal sieve that is arranged at the end of the chute, opposite the entry port. For example, and with reference to FIGS. 4 and 5, the solid slug 368 may be received by the terminal sieve 360 upon progressing through the chute 340. For example, the solid fuel slug 368 may be received fully within the tube volume 366 of the tube 362 that defines the terminal sieve 360. At operation 820, the solid slug held within the terminal sieve is caused to be dissolved into a liquid molten salt (e.g., molten fuel salt and/or a secondary coolant salt). For example, and with reference to FIGS. 4-6, the terminal sieve 360 is arranged within the reactor access vessel 402 and within a flow path 409 of the liquid molten salt loop of the associated MSR. Accordingly, at least some liquid molten salt from the flow path 409 may enter the terminal sieve 360 via the perforated slits 364. Further, at least some liquid molten salt may flow to the terminal sieve 360 via the dilution passage 367. The presence of such liquid molten salt in the terminal sieve 360 (and associated tube volume 366) may interact with and serve to dissolve the solid slug 368 held therein.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1.-23. (canceled)

24. A system comprising
a fuel loading system comprising a sieve, the fuel loading system configured to introduce a fuel slug into a circulated liquid flow of molten salt and control the dissolution therein, using the sieve; and
a concrete structure defining a thermal and radioactive barrier about a vessel having the circulated liquid flow,
wherein the fuel loading system introduces said fuel slug through a passage in the concrete structure.

25. The system of claim 24, further comprising an inert gas system configured to manage a gas environment about the circulated liquid flow of molten salt.

26. The system of claim 25, wherein the gas environment is a pressurized inert gas environment.

27. The system of claim 24, wherein
the system further comprises a vessel including the circulated liquid flow of molten salt, and
the vessel is disposed within the concentrate structure.

28. The system of claim 27, wherein the fuel loading system further comprises a control mechanism configured to permit the selective release of the fuel slug into the vessel via the sieve.

29. The system of claim 28, wherein the control mechanism is disposed outside of the concrete structure and elevationally above the vessel.

30. The system of claim 29, wherein
the fuel loading system further comprises a chute extending between the control mechanism and the vessel, and
upon the selective release of the fuel slug by the control mechanism, the chute permits a gravitationally induced movement of the fuel slug toward the sieve, the sieve disposed within the concentrate structure.

31. The system of claim 24, further comprising a fuel salt pump configured to induce flow of the circulated liquid flow of molten salt.

32. A system comprising
a reactor vessel configured to circulate a liquid molten salt therethrough, and
a fuel loading system configured to selectively release a fuel slug into the circulated liquid molten salt of the reactor vessel through multiple layers of containment, vessels, shielding and/or other barriers,
wherein,
the nuclear fuel is stored in a fuel storage that is physically separated from the reactor vessel, and
the fuel loading system operates to control and support a dissolution of the fuel slug into the circulated liquid molten salt.

33. The system of claim 32, wherein the fuel loading system further comprises a sieve configured to hold the fuel slug at least partially in the circulate liquid molten salt.

34. The system of claim 33, wherein the sieve comprises a plurality of perforated slits configured to permit a release of a portion of the fuel slug into the circulated liquid molten salt.

35. The system of claim 34, wherein the plurality of perforated slits permit an introduction of a liquid molten salt flow therein.

36. The system of claim 32, wherein
the system further comprises a circulation pump configured to induce circulation of the circulated liquid molten salt, and
the circulation pump and the sieve cooperate to adaptively control and support the dissolution of the fuel slug into the circulated liquid molten salt.

37. The system of claim 32, further comprising an inert gas system configured to manage a gas environment about circulated molten salt.

38. The system of claim 32, wherein
the system further comprises a concrete structure defining a thermal and radioactive barrier about the reactor vessel, and
the fuel loading system comprises a control mechanism disposed outside of the concrete structure and a sieve disposed within the concrete structure.

39. The system of claim 38, wherein the control mechanism is configured to permit the selective release of the fuel slug into the reactor vessel via the sieve.

40. A system comprising
a reactor vessel; and
a fuel loading system comprising a slug loading assembly, a chute, and a terminal sieve,
wherein,
the terminal sieve is positionable within a liquid molten salt for dissolution of a solid fuel slug therein, and
the liquid molten salt is a circulated flow thereof within the reactor vessel.

41. The system of claim 40, wherein the fuel loading system permits entry of the solid fuel slug into the circulated flow of the liquid molten salt under inert conditions.

42. The system of claim 40, wherein the fuel loading system permits entry of the solid fuel slug into the circulated flow of the liquid molten salt under a vacuum.

43. The system of claim 40, further comprising one or more isolation points between the slug loading assembly and the terminal sieve.
